(19) United States
(12) Patent Application Publication
(10) Pub. No.: US 2013/0338986 A1
(43) Pub. Date: Dec. 19, 2013

(54) QUALITY CONTROL OF SUB-SURFACE AND WELLBORE POSITION DATA

(71) Applicants: Erik Nyrnes, Trondheim (NO); Jo Smiseth, Stavanger (NO); Bjørn Torstein Bruun, Stavanger (NO); Philippe Nivet, Stavanger (NO)

(72) Inventors: Erik Nyrnes, Trondheim (NO); Jo Smiseth, Stavanger (NO); Bjørn Torstein Bruun, Stavanger (NO); Philippe Nivet, Stavanger (NO)

(73) Assignee: STATOIL PETROLEUM AS, Stavanger (NO)

(21) Appl. No.: 13/996,432

(22) PCT Filed: Dec. 21, 2011
(86) PCT No.: PCT/EP2011/073695

§ 371 Date: Sep. 5, 2013

(30) Foreign Application Priority Data
Dec. 21, 2010 (GB) 1021542.4

(51) Int. Cl. G06F 17/50

(52) U.S. Cl. CPC G06F 17/5009
USPC 703/10

(57) ABSTRACT

There is provided a method of assessing the quality of subsurface position data and wellbore position data, comprising: providing a subsurface position model of a region of the earth including the subsurface position data, wherein each point in the subsurface position model has a quantified positional uncertainty represented through a probability distribution; providing a wellbore position model including the wellbore position data obtained from well-picks from wells in the region, each well-pick corresponding with a geological feature determined by a measurement taken in a well, wherein each point in the wellbore position model has a quantified positional uncertainty represented through a probability distribution; identifying common points, each of which comprises a point in the subsurface position model which corresponds to a well-pick of the wellbore position data; deriving for each common point a local test value representing positional uncertainty: selecting some but not all of the common points and deriving a test value from the local test values of the selected common points; providing a positional error test limit for the selected common points; and comparing the test value with the test limit to provide an assessment of data quality.

### FIELD OF THE INVENTION

The invention relates to methods of assessing the quality of subsurface position data and wellbore position data.

### BACKGROUND OF THE INVENTION

This document aims at highlighting the main differences between the methodology for data quality assurance presented in the patent application and existing technology implemented as a part of commercial software or published.

In any problem where an unknown quantity is to be predicted with the help of known or measured other (explanatory) quantities, it is of crucial importance to pay particular attention to the calibration between the two sets of variables. In many cases, this calibration is achieved by statistical methods (e.g. least squares regression) with the help of a pool of experimental data (training set) where both predicted and explanatory variables are present. Ideally, data values from the training set should be dispersed enough and be related in a clear way along a functional relationship, so that the predicted variable can be modelled as the sum of this functional combination of the explanatory variables and of a small residual. Classical pitfalls to statistical calibration include insufficient data dispersion, too important residual, and the presence of outlier data in the training set, whether it results from a wrong measurement, or from measurements that are representative from another system. These important residuals will be referred to as gross errors in the following. To handle gross errors, specific methodologies known as “robust statistics” (Huber 1981) have been developed to try to minimize their impact on the calibrated model. Another approach used within the classical statistical framework consists in analyzing the distribution of the estimated residuals. A first way to analyze this distribution is to highlight the values corresponding to the lowest and highest percentiles of the distribution. However, this first simple approach is insufficient to tell whether these extreme residual values are acceptable or not. To put it differently, the most severe residuals may not automatically denote a gross error.

A more systematic approach consists in normalizing each estimated residual with an estimation of the estimation error produced by the statistical model. This normalized, also called studentized, residual is compared to a known statistical distribution in order to detect if it is significant or not (Cook 1982). This technique is used in many practical situations, which includes commercial software dedicated to convert interpreted time horizons to depth and to adjust the model to well-pick positioning information. An example of such an application is the software Cohiba (Arne Skorstad et. al, 2010, see reference below), developed by the Norwegian computing centre (NR: Http://www.nr.no) and presented for instance in Abrahamsen (1993). In this application, input parameters are the horizon maps interpreted in the seismic time domain (TWT); interval velocity maps describing the lateral variations of the velocity of acoustic waves in each layer, and their associated uncertainties. Such horizons represent boundaries between geological layers. The horizons are converted to the depth domain using a simple 1D model (Dix, 1955) combining at each position the velocities and interpreted horizon time, which gives an initial trend model for the horizons. The linearization of this model, combined with the initial input uncertainties, allows computing an initial covariance model describing the uncertainties on all horizon positions, velocities and their interactions. Well-picks are 3D points interpreted along a well path that indicate where the well path intersects the different horizons. This information can then be used to condition the multi-horizon initial trend model, resulting in an adjusted trend model and adjusted trend uncertainty. This information forms the basis to the QAQC (Quality Assurance/Quality Control) procedure implemented in Cohiba: For each well-pick, an estimated residual and error estimation is extracted from the estimated trend allowing the computation of studentized residuals, which are finally analyzed to detect outliers.

Finally, we could also mention, as an additional possibility to detect outliers, the cross-validation techniques (Geisser 1993). The general principle of these techniques consists in partitioning the training dataset in two pieces: one effectively used for the calibration, and another one used for testing the predictability of the model. This technique has two advantages of providing for each test data a residual estimation that is really independent from this data. Moreover, the technique does not need any parametric assumptions (Gaussian input) to be applied. As a practical implementation of a particular cross-validation technique in the domain of geostatistical depth-conversion of a multi-horizon model, we can mention the ISATIS/ISATOIL geostatistical software (http://www.geovariances.fr). Whereas the basis for depth conversion is similar to the one used in Cohiba, the validation of picks (and detection of gross errors) is achieved by removing sequentially one well-pick at a time, estimating at this position the depth residual (by comparison between estimated horizon and well-pick depths), and comparing it with the estimated error at this position. The user can then remove the well-picks where gross errors have been detected from the calibration database.

The already disclosed arrangement can be used to generate necessary input to this invention, but is definitively not essential for applying the QC methodology comprised by this invention. Input can be generated form other types of commercial software for sub-surface positioning.

Background prior art references are:
A. Skorstad et. al, 2010, COHIBA user manual—Version 2.1.1, http://www.nr.no/files/sand/Cohiba/cohiba_manual.pdf
P. Abrahamsen, 1993, Bayesian Kriging for Seismic Depth Conversion of a Multi-layer Reservoir, in A. Soares (ed.) Geostatistics Troia '92, Kluwer Academic Publ., Dordrecht, 385-398
R. D. Cook, 1982, Residuals and Influence in Regression, Chapman and Hall.
C. H. Dix, 1955, Seismic velocities from surface measurements, Geophysics, 20, no. 1, 68-86
P. J. Huber, 1981, Robust Statistics, Wiley.
P. Hubral, 1977, Time migration: some ray-theoretical aspects, Geophysical Prospecting, 25, no. 4, 738-745
S. Geisser, 1993, Predictive inference: an introduction, Chapman and Hall.

### SUMMARY OF THE INVENTION

The invention provides methods of assessing the quality of subsurface position data and wellbore position data as set out in the accompanying claims.

The method for Quality Control (QC) described in this document is useful to verify the quality of the 3D positions of well-picks, seismic data (non-interpreted and interpreted) and interpreted sub-seismic data. A well log is a record of physical measurements taken downhole while drilling. A well-pick is a feature in a well log that matches an equivalent feature of the combined seismic and sub-seismic model. These pairs of features are hereafter denoted geological common points, i.e. a common point is a common reference between a position in the wellbore position model and a position in a subsurface position model. The combined seismic and sub-seismic model will be denoted as the sub-surface model. The quality control is carried out by calculating test parameters for the geological common points. If a test parameter does not match predefined test criteria the conclusion is that the corresponding geological common points are affected by gross errors.

The invention seeks to perform QC of sub-surface and wellbore positional data using statistical hypothesis testing. QC in this context is the process of removing gross errors in wells and the sub-surface model, such as wrongly surveyed wells or wrongly interpreted faults and horizons. The sub-surface model and well positional data will also be referred to as observation data. The term gross error does not necessarily refer to single observations, but is also introduced to represent any significant mismatch between the positions of geological features according to well log data compared with the sub-surface model. A mismatch can for instance be an error affecting the 3D coordinates of several well-picks in the same well equally, such as an error in the measured length of the drill-string. Other examples are wrong assumptions about the accuracy of larger and smaller parts of the observation data and incorrect assumptions of the parameters of the seismic velocity model.

The position accuracy of the subsurface positional model is improved by adding wellbore positional information. Several geostatistical software packages provide such functionality. Sub-surface and wellbore position data can be combined and adjusted according to certain adjustment principles, such as the method of least squares. Detection of gross errors is vital in order to ensure optimal accuracy of the output from all kinds of subsurface positional estimation. A gross error in either a well-pick or the sub-surface model will lead to unexpected positional inconsistency. This might for instance increase the probability of missing drilling targets. QC of input data is especially important when the estimation principle is based on the method of least squares, since this method is particularly sensitive to gross errors in observation data. Most software for subsurface position uses the principle of least squares to combine and adjust data from wells and the sub-surface model. Statistical testing is based on objective evaluation criteria. Consequently, the QC method which is developed can therefore be applied with minor human intervention. The method therefore has the potential of being carried out automatically.

The methods and concepts presented here are capable of quantifying the size of gross errors and corresponding uncertainties. The framework and the concept can be applied for diagnosing purposes in order to pinpoint the cause of the error. For example, it can be decided whether a mismatch is due to a gross error in e.g. a single well-pick, a number of well-picks from the same or different wells, or a systematic error in the entire well. If the software for instance detects an error in the vertical components of all well-picks in the vertical direction, the cause might be an error in the depth reference level. It will also be possible to decide whether the gross errors are related to the position of one or more well-picks or the corresponding geological common points.

### BRIEF DESCRIPTION OF THE FIGURES

FIG. 1 shows a number of seismic horizons, representing geological surfaces, a wellbore trajectory, and a number of well-picks; and is used in the discussion of Step 2 of a preferred embodiment;

FIG. 2 shows a diagram similar to that of FIG. 1, and is used in the discussion of Step 3 of a preferred embodiment; and

FIG. 3 shows a diagram similar to those of FIGS. 1 and 2, and is used in the discussion of Step 4 of a preferred embodiment.

### DESCRIPTION OF PREFERRED EMBODIMENTS

Our starting point is that we have a sub-surface model and a wellbore position model, which effectively represent two different models of reality, with the former being based for example on seismic data and the latter being based on positional data derived from a wellbore.

The method for QC evaluates the match between predefined test criteria and parameters calculated from observation data to decide whether geological common points are affected by gross errors. In this section the goal is to explain how the QC parameters are calculated, without using mathematical expressions. The methods for detection of gross errors presented here are based on utilizing outputs from an adjustment (e.g. least squares adjustment) of sub-surface and wellbore positional data. The outputs of interest are the updated positions of the subsurface and wellbore positional data and the corresponding covariance matrix (or variance matrix) which represents the quantified uncertainties of the updated positions. Other outputs of interest are the residuals (e.g. least squares residuals) and the covariance matrix (or variance matrix) of the residuals which represents the quantified uncertainties of the residuals. The residuals are the differences between the initial and updated positions of the subsurface and wellbore positional data. The covariance matrix of the residuals can be calculated from the covariance matrix of the updated positions of the subsurface and wellbore positional data.

The quantified positional uncertainty of each of the points in the adjusted model, which is given by a common covariance matrix, is representative for a certain predefined probability distribution. It is assumed that the covariance matrix is quantified and that the probability distribution is known before the QC tests are performed.

The test procedure is divided into several steps, which can be applied individually or in a combined sequence. In all steps the size of the gross errors is estimated along with corresponding test values. The estimated sizes of the gross errors are useful for diagnosing purposes. We have chosen to divide the test methodology into four steps. A summary of each step is given below.

### Step 1: Test of the Overall Quality of the Observation Data.

This step is the most general part of the quality control. This step is especially beneficial to apply the first time a sub-surface estimation software is applied to a unknown dataset set with unknown quality. In such a case a lot of wells are introduced and adjusted together for the first time, and the probability of gross error is therefore likely, since the data has not been exposed to such a type of quality control. A statistical test will be used to test whether the estimate \hat{σ}² of the variance factor σ² is significantly different from its a priori assumed value, denoted σ₀². The estimated variance factor is given by:

$${\hat{σ}}^{2} = \frac{{\hat{e}}^{T} {Q}_{ee}^{- 1} \hat{e}}{n - u}$$

where ê is a vector of so-called residuals that reflect the match between the initial and adjusted well-pick position, Qₑₑ⁻¹ is the covariance matrix of the observations, and n−u are the degrees of freedom.

The hypotheses for this test are:

H₀: σ²=σ₀² and H_{A}: σ²≠σ₀²

H₀ is rejected at the given likelihood level α if:

$$\frac{{\hat{e}}^{T} {Q}_{ee}^{- 1} \hat{e}}{n - u} > {K}_{1 - \frac{α}{2}} or \frac{{\hat{e}}^{T} {Q}_{ee}^{- 1} \hat{e}}{n - u} < {K}_{\frac{α}{2}} ,$$

Where

$${K}_{1 - \frac{α}{2}}$$

denotes an upper (1−α/2) percentage point of a suitable statistical distribution. The test value can be found in statistical look-up tables. The distribution of the test value has to be equal to the distribution of the test limit. The likelihood parameter a is often called the significance level of the test, which is the likelihood of concluding that the observation data contain gross errors when in fact this is not the case. The likelihood level is therefore the probability of making the wrong conclusion, i.e. concluding that gross errors are present when they are not.

A rejection of the null-hypothesis H₀ is a clear indication of unacceptable data quality, either that one or more observations are corrupted by gross errors or that a multiple of observations have been assigned unrealistic uncertainties. However, if this test is accepted, it may still be possible that gross errors are present in the data, so further testing of individual observations will be necessary. Normally, the significance level of this test should be harmonized with the significance level used for the individual gross error tests (will be explained later) such that all tests have similar sensitivity. The significance level used in this step of Quality Control therefore has to be set with careful consideration.

Let us consider that a new well is planned to be drilled in an existing oil-field. The intention is to update the geological model of the field before the drilling of the new well begins, in order to increase the probability to reach the geological target. In order to ensure reliable results, all positional information about existing wells and the sub-surface model have to be quality controlled to verify the presence of gross errors and possible wrong model assumptions.

After the first run of the software of the invention, a relevant test value is evaluated. The size of the test value directly reflects how serious the problem is with respect to data quality. For example, if the test value is only marginally larger than the test limit, there is most likely only one or perhaps only few gross errors present. These gross errors will be detected in Step 2 of the Quality Control, and their magnitudes will be estimated there as well. If the test value is smaller than the test limit, this might indicate that a group of observations have been assigned too pessimistic uncertainties (variances). A test value far beyond the test limit is a clear indication of a serious data quality problem. The reason might be that several corrupted observations are present, or that a number of observations have been assigned too optimistic uncertainties. Another possible reason is the use of a wrong or a too simple velocity model (i.e. assumptions about velocity in materials).

### Step 2: Testing for Gross-Errors in Each Observation.

In this step every well-pick and geological common point is tested against gross errors. The test for a gross error ∇ᵢ in the i^{th} observation yᵢ may be formulated with the following hypotheses:

H₀: ∇ᵢ=0 and H_{A}: ∇ᵢ≠0

The gross error estimate \hat{∇}ᵢ, for instance in the vertical direction, can be found by:

$$[ \begin{matrix}\hat{β} \\ {\hat{∇}}_{i}\end{matrix} ] = {{( {[ X c ]}^{T} {Q}_{ee}^{- 1} [ X c ] )}^{- 1} [ X c ]}^{T} {Q}_{ee}^{- 1} y$$

where \hat{β} is a vector of estimated parameters like coordinates, velocity parameters etc., and the vector c^{T}=[0 . . . 010 . . . 0] consists of zeros, except the element that corresponds to the actual observation which is about to be tested. This element consists of the number one. The matrix X defines the mathematical relationship between unknown parameters in β and the observations in y. The vector c is an additional vector which is introduced to model the effects of a gross error. The dimension of c equals the number of observations in y. Methods for estimation of a gross error and the uncertainty of the gross error as function of the residuals and the residual covariance matrix are described in the literature.

The test value for testing the above hypotheses is given by:

$$t = \vert \frac{{\hat{∇}}_{i}}{{σ}_{{\hat{∇}}_{i}}} \vert$$

where σ_{\hat{∇}} is the standard deviation of the estimator \hat{∇}ᵢ of the gross error ∇ᵢ. The null hypothesis H₀ is rejected when the test value t is greater than a specified test limit, denoted t_{α/2}. The test limit t_{α/2} the limit at which a given well-pick is classified as a gross error or not, and is the upper α/2 quantile of a suitable statistical distribution. A rejection of H₀ implies that the error ∇ᵢ of the i^{th} observation yᵢ is significantly different from zero and the conclusion is that this observation is corrupted by a gross error. Test limits as a function of various likelihood levels can be found in statistical lookup tables. A commonly used likelihood level is 5%. The distribution of the test value has to be equal to the distribution of the test limit.

If σ² is known, i.e. not estimated, the distribution of the test statistic t will be different from the case when the variance factor σ⁻² is unknown.

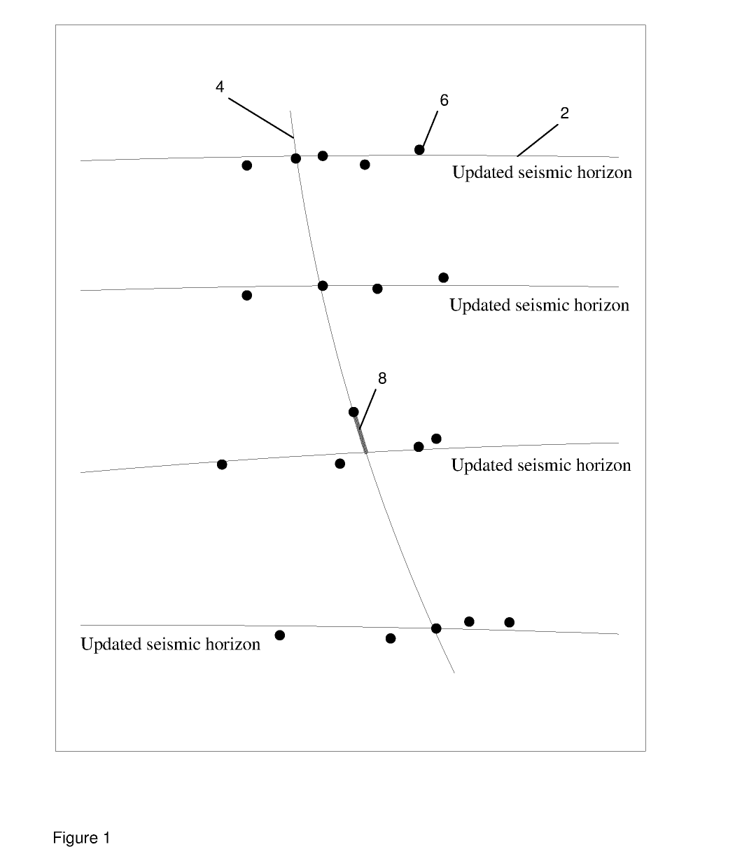

Let us suppose that the test in Step 1 has been applied, and that this test has indicated that gross errors are present in the observation data. Then, the next step will be to check if any of the well-picks in the data set is affected by gross errors. See FIG. 1 for further explanation.

FIG. 1 shows a number of seismic horizons 2, representing geological surfaces, a wellbore trajectory 4, and a number of well-picks 6. In FIG. 1 one of the well-picks in third surface from the top is corrupted by a gross error. Well-picks are indicated by black solid circular dots 6. All surfaces have been updated according to neighboring well-picks. The corrupted well-pick does not fit to the adjusted surface due to the gross error which acts as an uncorrected bias. The gross error is indicated by the thick line 8.

### Step 3: Test for Systematic Errors.

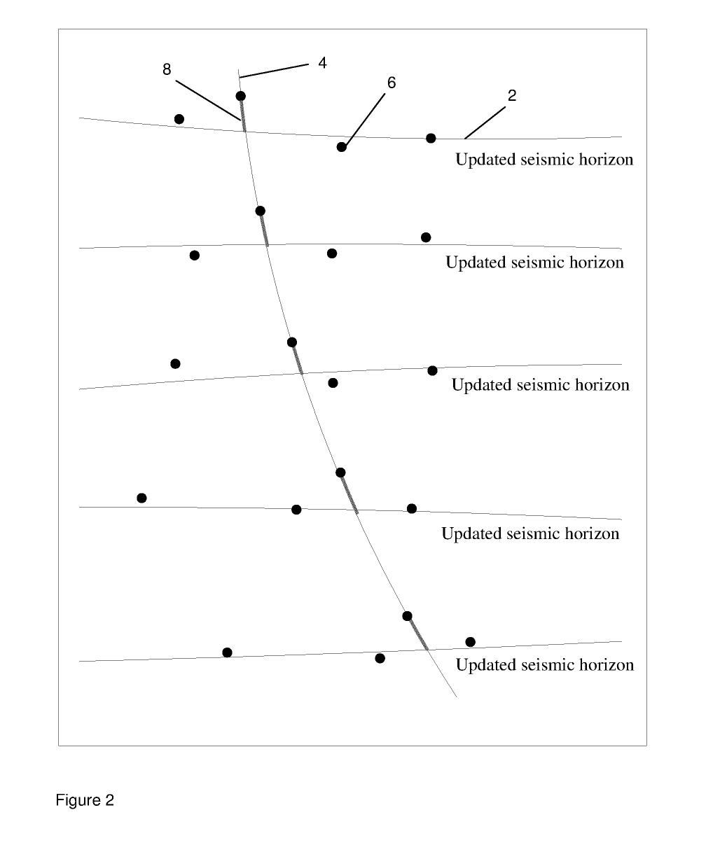

The quality of specified groups of well-picks is tested individually. Examples of such groups can be well-picks within certain wells, subsea templates, horizons and faults. For example, the test can be executed by testing the 3D coordinates of the well-picks within each well successively. If a well is corrupted by a vertical error or a lateral error, affecting the major part or the entire well systematically, it will be detected in this step. The test is especially relevant when several well-picks are corrupted by gross errors. This might be the case when an entire well is displaced in a systematic manner with respect to its expected position. An example is shown in FIG. 2.

This test is similar to the test presented in Step 2, except that instead of estimating the gross errors for each observation individually, the gross errors are estimated and tested for more than one well-pick simultaneously. Thus, for Step 3, more than one element in the vector c consists of the digit one (when testing for vertical error) in order to model the effects of a gross error, in terms of a bias ∇, that affects more than one well-pick simultaneously.

The hypotheses for this test can be formulated by:

H₀: ∇=0 and H_{A}: ∇≠0

Note that the bias ∇ in this case may represent a common bias in several well-picks in the same well, or a bias in several well-picks in the same seismic horizon or fault. The gross error ∇ can be estimated by the expression

$$[ \begin{matrix}\hat{β} \\ \hat{∇}\end{matrix} ] = {{( {[ X c ]}^{T} {Q}_{ee}^{- 1} [ X c ] )}^{- 1} [ X c ]}^{T} {Q}_{ee}^{- 1} y$$

where in this case more than one element in the vector c consists of ones. These are the elements that correspond to the well-picks involved in the systematic error.

It is not necessarily the case that the depth error has occurred in the upper part of the wellbore. However, in cases where the depth errors have occurred at other well-picks further down the well, the test for systematic errors can be carried out in accordance with a “trial and error” approach. By performing the step 3 test systematically for all possible sequences of well-picks in all the wells or other features, the most severe systematic error may be detected by comparing test values. The test with the highest test value above the test limit is the most probable systematic error.

The above mentioned procedure can also be used to detect systematic errors in lateral coordinates. In addition, this procedure can be used to detect systematic errors in the north, east and vertical direction simultaneously for an entire well. In this step, the quality of all well-picks in a specific well or a horizon etc., shall be tested. Moreover, all wells in the data set shall be tested successfully. Note that this procedure bears similarities to the procedure in Step 2, except that the test involves several well-picks rather than one single well-pick.

FIG. 2 shows a situation similar to the example given in the FIG. 1. In this case, however, the gross error has affected several well-picks equally rather than one single well-pick. This situation is typical when the measured depth of the drill-string has been affected by a gross error. Well-picks are indicated by black solid circular dots 6 while the gross errors are indicated by thick lines 8.

### Step 4: Test for Systematic Errors and Gross Errors Simultaneously

In this step the quality of groups of well-picks and individual well-picks are tested simultaneously by one single statistical test. Thus, this part of the quality control is especially useful to detect several gross errors simultaneously, and thereby hinder masking effects, i.e. that a test in one well-pick may be affected by errors in other corrupted well-picks, as would have happened in the single well-picks tests of Step 2. The user selects single well-picks and/or a multiple of well-picks based on the interpretations of the results from Steps 1, 2 and 3. The selected well-picks can be well-picks which are not proven to be gross errors by Step 2 and 3, but which the user suspects are affected by gross errors. The test concludes whether the selected well-picks will cause significant improvements to the overall quality of the observation data if they are excluded from the dataset. The well-picks are tested for exclusion individually or as groups containing several well-picks potentially corrupted by systematic errors.

This test will be especially useful in cases where the user suspects that systematic errors and gross errors in well-picks are present in such a manner that they cannot be detected and identified by the tests in Step 2 and Step 3. This might be due to masking effects, that is, if a gross-error that is not estimated masks the effects of a gross error which is estimated. This might be the case if several well-picks are corrupted, either in terms of several gross errors in several well-picks and/or if systematic errors are present in several wells. By applying this test procedure, the user is able to estimate the magnitude of all these errors simultaneously, and perform a statistical test to decide whether all these well-picks simultaneously can be considered as gross errors. It is important to notice that one single common test value is calculated for all these well-picks, although the errors in all selected well-picks are estimated.

Note that in this test approach the test is not carried out in a successive manner like the tests in Step 2 and Step 3. In this test we calculate one common test value for all estimated errors, systematic for several well-picks or individually for single well-picks.

The test can be summarized in the following steps:

a) Select which well-picks to be tested for exclusion.
b) Sort out which well-picks are believed to represent gross errors in individual well-picks, and groups of well-picks that are believed to represent systematic errors.
c) Estimate the errors in the selected well-picks
d) Calculate the common test value for the selected well-picks. This test value is a function of the errors estimated in previous step (step c.).
e) Check if the common test value for the selected well-picks is greater than the test limit. If so, the selected well-picks constitute a gross model error and shall be excluded from the dataset, otherwise not.

In Step c above the errors (denoted v) are estimated by the following equation:

$$[ \begin{matrix}\hat{β} \\ \hat{∇}\end{matrix} ] = {{( {[ X Z ]}^{T} {Q}_{ee}^{- 1} [ X Z ] )}^{- 1} [ X Z ]}^{T} {Q}_{ee}^{- 1} y$$

where the vector \hat{β} consists of the estimates of parameters like coordinates, velocity parameters etc., and \hat{∇} is a vector of the estimates of the gross errors in certain directions; either north, east or vertical. The vector y contains the observed values of coordinates and velocity parameters which constitutes the dataset of the model. The coefficient matrix X defines the mathematical relationship between the unknown parameters β and the observations in y. The coefficient matrix Z defines the relationship between the gross errors ∇ and the observations in y, and is specified in steps a. and b. above. This matrix can be used to model any type of model errors depending on the choice of coefficients.

The test value Tᵢ can be calculated by:

$${T}_{i} = \frac{{\hat{∇}}^{T} {Q}_{\hat{∇} \hat{∇}}^{- 1} \hat{∇}}{r ( \frac{{\hat{e}}^{T} {Q}_{ee}^{- 1} \hat{e}}{n - u} )}$$

Where Q_{\hat{∇}\hat{∇}}⁻¹ is the covariance matrix of the estimated gross errors, r is the number of elements in the vector \hat{∇}, ê is a vector of residuals that reflect the match between the initial and adjusted well-pick position, and n−u are the degrees of freedom.

The gross error test can be formulated by the following hypotheses:

H₀: ∇=0 and H_{A}: ∇≠0

The hypothesis H₀ states that there are no gross errors present in the data, i.e. the model errors ∇ are zero. The alternative hypothesis H_{A} states that the model errors are different from zero. If the test value is greater than the test limit the conclusion is that the model error is a gross error. The test limit is dependent of the likelihood level a which defines the accepted likelihood of concluding that a well-pick is a gross error when in fact it is not. Test limits as a function of various likelihood levels can be found in statistical lookup tables. A commonly used likelihood level is 5%. The distribution of the test value has to be equal to the distribution of the test limit.

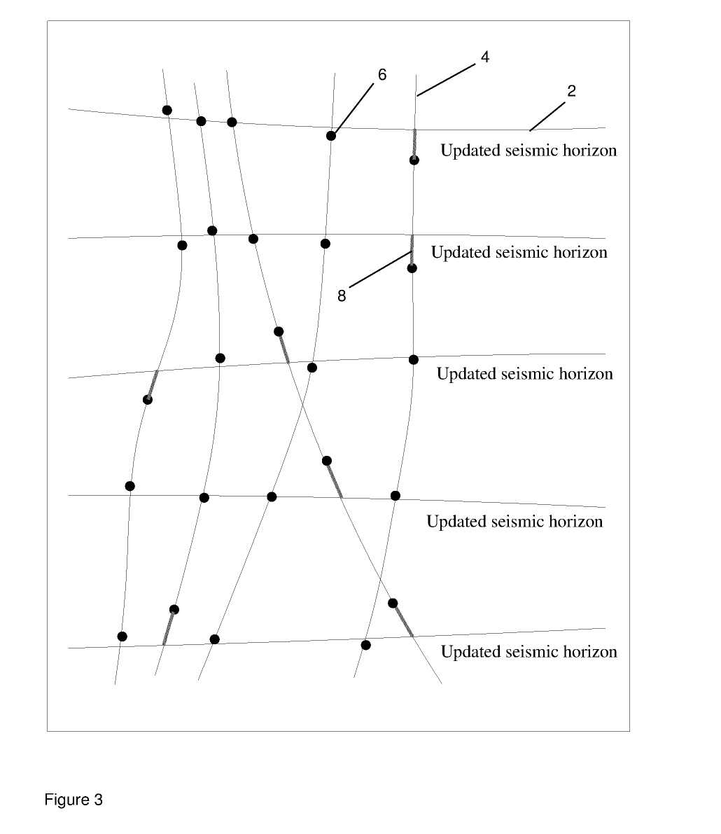

Consider the situation shown in FIG. 3. The thick lines 8 show which well-picks are corrupted by gross errors. The first well from the left is corrupted by one single gross error, which is the third well-pick from above. The user can suspect this based on the results from Step 2 and 3. The magnitude of the error has already been estimated in these steps. The error estimate is suspiciously large, although not large enough to be excluded based on Step 2 and 3. The user therefore selects this as a candidate for testing in Step 4. The situation is the same for the lowest well-pick in the second well from the left, and the user therefore selects this well-pick too. In the third well from the left, the results from previous tests have indicated a systematic shift in three of the well-picks. This shift has not been detected by the previous tests. The user selects these well-picks as candidates for testing, but chooses to consider them as a common error for all three well-picks, because this error seems to be a systematic error. The same situation applies for the two uppermost well-picks in the well on the right-hand side of FIG. 3. In this example, the software estimates four errors in total, of which two of them are systematic. The software also calculates one single test value common for this selection of well-picks, to decide whether all these well-picks shall be excluded from the data set as a group.

In FIG. 3 several well-picks are affected by gross errors, in terms of errors in individual well-picks and systematic errors. When the measured depth has been affected by a gross error affecting several well-picks down the well, this may be causing a similar shift in the respective well-picks. Well-picks 6 are indicated by black solid circular dots while the gross errors are indicated by thick lines 8 on the wellbore trajectories 4.

### Practical Example of Application

The following scenario will hopefully demonstrate the usefulness of the methods described herein. The scenario occurs in an oil-field in the Norwegian Sea. The oilfield is perforated by 30 production wells and 5 exploration wells. The stratigraphy of the field is typical for the area, and the reservoir is found in the Garn and Ile formations. Seismic horizons have been interpreted from time-migrated two-way-time data. The field is relatively faulted. A few faults have been interpreted in two-way-time. Well observations have been made for all the seismic horizons and some of the interpreted faults.

The asset team has depth converted the seismic horizons and faults using seismic interval velocities. Moreover, positional uncertainties in horizons, faults, and well-picks, including the dependencies between them are represented in a covariance matrix. A structural model in depth was created by adjusting the depth converted horizons and faults with well observations of horizons and faults. The uncertainties of seismic features and positional well data in 3D were obtained by including the covariance matrix in the least squares adjustment approach. A software tool has been applied to perform the adjustment.

### Quality Check

In order to quality check the input parameters to the depth converted model, the methods described herein were performed. An overall quality check was performed (Step 1), and a test value was calculated. The hypothesis of this test is whether the initial uncertainties of the observation data are within specification or not. The test value of this test turned out to be 10.3, which is higher than the upper test limit of 1.6. This implies that there is an inconsistency between the depth-converted positions and well-pick positions with regards to uncertainties and dependencies (correlations). More specifically, a test value which is higher than the test limit indicates that the deviations between one or more well-picks and the corresponding horizon or fault positions are higher than, or do not harmonize with the uncertainty range of those positions. This is evidence of inconsistency present in the data, but the cause of inconsistency is not clear.

As an attempt to identify the cause of failure of the overall QC test, the gross error test of each individual well-pick is performed for all horizons and faults (Step 2). The test limit of the gross error test for this particular data set is 2.9. The test values for several well-picks are higher than the limit, and the well-picks of Well A exhibit the highest test values. The bias in the vertical direction calculated for all of the well-picks in Well A are positive and approximately 10 metres. At this point the procedure will be to investigate the input data associated with the well-picks of highest test value. However, after identifying a systematic bias in the vertical direction in Well A, it is natural to perform a systematic gross error test on all the well-picks in that well (Step 3), and to decide whether the common bias in these well-picks is a gross error (i.e. significantly different from zero) or not. After running the Step 3 test for all wells in the field, the A test value of Well A is 4.4. With a test limit of 2.1, it is the only well with a test value above the test limit. The corresponding bias is estimated to 10.1 metres. The well survey engineer is consulted, and the reason for the bias is found to be an error in the datum elevation of 10 metres. This explains the systematic error in the vertical direction for the well-picks of Well A.

The surveys and the well-pick positions of Well A were corrected. Subsequently, the overall quality check test (Step 1) was run with a test value of 1.8, which is still higher than the upper test limit of 1.6. The user is therefore aware that some other well-picks in the dataset might be corrupted. The user will also suspect this based on the results from the tests of Step 2, because the error estimates for some well-picks turned out to be suspiciously large (Wells B and C), but not large enough to have significant effect on their respective test values from Step 2. This was also the case for the systematic error tests of Step 3 for two other wells, Wells D and E. One well-pick in Well B is suspected to be corrupted by a gross error, which is the second well-pick of horizon no. 2 from above. The user could already suspect this from Step 2, where the magnitude of the error was estimated to 12.3 metres. This error estimate is suspiciously large, although not large enough to be excluded based on the results from Step 2. However, the user therefore selects this as a candidate for testing in Step 4. The situation is the same for the lowest well-pick in Well C, and therefore the user also selects this well-pick as candidate for testing. In the Well D, the results from Step 3 have indicated a systematic shift in four of the well-picks. This shift is in the downward direction for all four well-picks and estimated to 7 metres in magnitude. However, this bias (gross-error) has not been detected by the tests of Step 3. Also in Well E there is a systematic shift in the upward direction for three sequential well-picks.

When the user shall perform the quality control tests in Step 4, all the mentioned well-picks have to be selected from Well B, C, D and E. The program estimates a common shift, in terms of a bias, for the actual well-picks in Well D, and a common shift for the actual well-picks in Well E. The program also estimates a bias for each of the well-picks in Wells B and C. In total, the software estimates four errors, of which two of them are systematic. Finally, the program calculates a common test value for all these well-picks. If this test value is larger than the test limit, all the relevant well-picks has to be excluded from the data set in order to obtain a reasonable data quality. The conclusion will be that all these well-picks together constitute a model error that consists of both systematic errors and gross errors in individual well-picks.

The surveys and the well-pick positions were corrected. Subsequently, the overall quality check test (Step 1) was run with a test value of 1.1, with a lower acceptance limit of 0.6 and an upper acceptance limit of 1.6. Moreover, the single well-pick gross error test (Step 2) was run with no test values above the test limit of 2.9. The systematic well error test (Step 3) was run without any test values above the test limit. This implies that input positions, velocities, uncertainties and correlations are consistent, and the depth converted structural model is considered to be of sufficient quality.

### Consequences

The gross errors detected in this case lead to significant errors in the structural model. The positions of horizons and faults penetrated by Well A were significantly affected by the bias in the datum elevation of the well. The structural model is applied for well planning and drilling operations purposes, as well as the a priori uncertainty model for history matching of the reservoir model, and for bulk volume calculations. Well A only penetrated the upper part of the reservoir, and the bias was therefore only introduced in that part of the reservoir. Consequently, the gross errors created a bias in the bulk reservoir volume calculations, which resulted in significant errors in the estimated net present value of the remaining reserves. The initial reservoir uncertainty model is based on the structural model. Consequently, a history match of reservoir model with the production history of the oil field would be affected by the gross error in the well observations. The history matched reservoir model is applied for predictions of future production of the field. A wrongly biased history matched reservoir model will give errors in the estimated future production figures and the total value of the field.

The technology presented in the present application allows also detecting gross errors on well-picks based on a multi-layer depth conversion technique. However, there are major differences with the previously presented techniques: The depth conversion technique itself is based on a 2.5 D model (called image ray-tracing or map migration; Hubral, 1977). This implies that the model estimates the three coordinates from each interpreted horizon pick as well as a consistent covariance model. In the case of dipping horizons, this technique provides a more accurate estimation of the position of the horizons. However, this benefit is offset by the cost.

This invention can be considered as a concept for QC that comprises several types of methods to provide an indication of data quality. QC is not restricted to individual well-picks as is the case for the two previous applications, since also a group of observations can be tested simultaneously (systematic errors, for instance all the well-picks from a single well, or all the well-picks from the same horizon). This functionality allows identifying the cause of the issues that may arise during the calibration of the model.

The methods and tests of the invention are not restricted to only testing whether the observation is a gross error or not, but they are also able to estimate the size of the gross errors for both single and a multiple of observations and their associated uncertainties. This is a significant difference from existing technology. Examples of test approaches are:

Testing gross errors in individual well-picks
Simultaneous testing a multiple of well-picks:
Several well picks in the same horizon/fault
Several well-picks in the same well
Several well-picks in the same well/horizon/faults and single well-picks
Testing gross errors in other input parameters (e.g. velocity model parameters)
Testing incorrect a priori assumption of the input variances/covariances of the observations. This can be considered as an overall quality test.

QC is performed in either 3D, 2D or 1D according to users requests.

Inputs required for applying the QC method are:

1. A priori uncertainties of the sub-surface model (i.e. covariance matrix of positions of horizon and faults of interests before adjusting to wells).
2. A priori uncertainties of wells, i.e. uncertainties of wells before they are used to adjust the sub-surface model.
3. Residuals, e.g. least squares residuals. These are simply the differences between the initial and updated positions of wells, and positional differences between the initial and updated sub-surface model. Updated refers to the case when the wells and sub-surface model have been combined and adjusted using a certain adjustment principle, such as the method of least squares. The uncertainties (covariance matrix) of the residuals are also required.
4. A matrix specifying which observations that is to be tested for the presence of gross errors. This matrix is a model that defines whether the tests shall be performed for single observations or for several observations simultaneously. This matrix is called the specification matrix.

The input can be obtained from commercial software packages.

The outputs from the methods of the invention may be:

1. Estimates of the errors in the initial positions of wells and sub-surface model. Estimated uncertainties of the estimated errors are also output.
2. Test values for evaluation of whether estimated errors are gross errors or not.

All tests can be performed in 3D. This is dependent on available data. However, tests can be applied in any of either North, East and Vertical direction if desired.

The invention will contribute to increase efficiency in several applications. Some examples of possible uses of the invention are:

QC of well planning
QC of volume calculations
QC of history matching of structural model/reservoir model
QC of well operations
QC of seismic interpretation
QC of well log interpretation

1. A method of assessing the quality of subsurface position data and wellbore position data, comprising:
providing a subsurface position model of a region of the earth including the subsurface position data, wherein each point in the subsurface position model has a quantified positional uncertainty represented through a probability distribution;
providing a wellbore position model including the wellbore position data obtained from well-picks from wells in the region, each well-pick corresponding with a geological feature determined by a measurement taken in a well, wherein each point in the wellbore position model has a quantified positional uncertainty represented through a probability distribution;
identifying common points, each of which comprises a point in the subsurface position model which corresponds to a well-pick of the wellbore position data;
deriving for each common point a local test value representing positional uncertainty:
selecting some but not all of the common points and deriving a test value from the local test values of the selected common points;
providing a positional error test limit for the selected common points; and
comparing the test value with the test limit to provide an assessment of data quality.

2. A method as claimed in claim 1, in which the selected common points relate to a common physical feature.

3. A method as claimed in claim 2, in which the common physical feature comprises one of a well, a subsea template, a horizon and a fault.

4. A method as claimed in claim 1, in which the selected common points relate to a group which are suspected of sharing a systematic error.

5. A method as claimed in claim 1, in which the selected common points comprise those which have been assessed as having an unsatisfactory data quality.

6. A method as claimed in claim 1,
wherein said step of selecting common points includes selecting well-picks to be tested for exclusion from the wellbore position model;
and the method further comprises, if the test value is greater than the test limit, excluding the selected well-picks from the wellbore position model.

7. A method as claimed in claim 6, wherein said step of calculating a test value comprises calculating only a single test value for all selected well-picks.

8. A method as claimed in claim 6, wherein said step of selecting well-picks to be tested for exclusion includes selecting both: a) individual well-picks which are believed to represent errors; and
b) groups of well-picks where each such group is believed to be affected by at least one error affecting all well-picks in the group.

9. A method as claimed in claim 6, wherein said step of selecting well-picks to be tested for exclusion includes selecting well-picks from more than one well.

10. A method as claimed in claim 1, which further comprises deriving an updated model of the region by adjusting at least one of the subsurface position model and the wellbore position model such that each common point has the most likely position in the subsurface position model and the wellbore position model.

11. A method as claimed in claim 1, wherein said subsurface position data is obtained from seismic data.

12. A method as claimed in claim 1, which further comprises repeating the steps of the method in an iterative manner.

13. A method as claimed in claim 2, in which the selected common points relate to a group which are suspected of sharing a systematic error.

14. A method as claimed in claim 3, in which the selected common points relate to a group which are suspected of sharing a systematic error.

15. A method as claimed in claim 2, in which the selected common points comprise those which have been assessed as having an unsatisfactory data quality.

16. A method as claimed in claim 3, in which the selected common points comprise those which have been assessed as having an unsatisfactory data quality.

17. A method as claimed in claim 4, in which the selected common points comprise those which have been assessed as having an unsatisfactory data quality.

18. A method as claimed in claim 2,
wherein said step of selecting common points includes selecting well-picks to be tested for exclusion from the wellbore position model;
and the method further comprises, if the test value is greater than the test limit, excluding the selected well-picks from the wellbore position model.

19. A method as claimed in claim 3,
wherein said step of selecting common points includes selecting well-picks to be tested for exclusion from the wellbore position model;
and the method further comprises, if the test value is greater than the test limit, excluding the selected well-picks from the wellbore position model.

20. A method as claimed in claim 4,
wherein said step of selecting common points includes selecting well-picks to be tested for exclusion from the wellbore position model;
and the method further comprises, if the test value is greater than the test limit, excluding the selected well-picks from the wellbore position model.
